(19) United States
(12) Patent Application Publication
(10) Pub. No.: US 2009/0028980 A1
(43) Pub. Date: Jan. 29, 2009

(54) EXTRUSION DIE FOR MOLDING HONEYCOMB STRUCTURES

(75) Inventor: Tadanobu ASAOKA, Takahama-shi (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 12/174,973

(22) Filed: Jul. 17, 2008

(30) Foreign Application Priority Data
Jul. 24, 2007 (JP) 2007-191779

(51) Int. Cl. B29C 47/30

(52) U.S. Cl. 425/382 R

(57) ABSTRACT

An extrusion die is used for producing a honeycomb structures. The extrusion die is composed of a guide ring and a die body part. Feeding holes and slit grooves are formed in the die body part. The guide ring has a pole part and a guide part. A slit groove formation area has a central slit groove formation surface area having a step shaped part and an outer peripheral slit groove formation area. An angle of the step-shaped part to an outer slit groove formation surface is within a range of 90°≦α≦95°, and a relationship A≦B<1.5 A is satisfied, where A is a gap between the outer peripheral slit groove formation surface to the guide part, and B is a gap between the outer peripheral side surface of the step shaped part and the front end of the guide part.

### CROSS-REFERENCE TO RELATED APPLICATION

This application is related to and claims priority from Japanese Patent Application No. 2007-191779 filed on Jul. 24, 2007, the contents of which are hereby incorporated by reference.

### BACKGROUND OF THE INVENTION

1. Field of the Invention

The present invention relates to an extrusion die for molding honeycomb structures by extruding ceramic raw material.

2. Description of the Related Art

There have been widely known a catalyst support on which a catalyst is supported. The catalyst support, supporting the catalyst thereon is capable of purifying specific components such as nitride oxide (NOx) contained in exhaust gas emitted from an internal combustion engine such as a diesel engine.

FIG. 6 is a perspective view of a honeycomb structure 8 as a final product produced using an extrusion die. In general, the honeycomb structure 8 is comprised of a plurality of cell walls 81, a plurality of cells 82 surrounded by the cell walls 81, and an outer peripheral skin 83 of a cylindrical shape. The cell walls 81 are covered with this outer peripheral skin 83. As shown in FIG. 6, the cell walls 81 are arranged in a honeycomb shape. The cell walls 81 form the cells 82. For example, a square shaped cell is surrounded by four cell walls 81.

The honeycomb structure 8 having the structure shown in FIG. 6 is generally produced by using an extrusion die. Ceramic raw material (or the “raw material” in short) is extruded through the extrusion die in order to mold a green body made of ceramic. The green body is then dried, and fired, and then produced as the honeycomb structure 8 as a final product.

There are various types of conventional extrusion dies in order to mold a green body made of ceramic, the shape of which corresponds to the honeycomb structure as a final product.

For example, Japanese patent laid open publication number JP 2002-283326 has disclosed a structure of a conventional extrusion die as shown in FIG. 10.

FIG. 10 is an explanatory view showing a cross section of such a conventional extrusion die 91 and an extrusion process of making an outer peripheral skin 83 and cell walls 81 of a honeycomb structure using the conventional extrusion die.

As shown in FIG. 10, the extrusion die 91 for molding a honeycomb structure which is comprised of a die body part 92 and a guide ring 95. The die body part 92 is composed of a plurality of feeding holes 931 and a plurality of slit grooves 941. Each feeding hole 931 is communicated with the corresponding skit groove 941. Raw material 80 is fed into the slit grooves 941 through the feeding holes 931 of the extrusion die 91. The slit grooves 941 are arranged in a honeycomb shape, and some of the slit grooves 941 face the inner surface of the guide ring 95.

The raw material 80 fed through the feeding holes 931 is extruded through the slit grooves 941 in order to mold a honeycomb structure 8. The guide ring 95 guides the raw material 80 which has been extruded through a part of the slit grooves 941 in order to make the outer peripheral skin 83 of the honeycomb structure 8. In addition, the die body part 92 has a step-shaped part 942 which is projected in the extrusion direction of the raw material. The surface of the step-shaped part 942 does not face the guide ring 95 as shown in FIG. 10.

On extruding the raw material 80 using the extrusion die 91 having the above structure, a part of the raw material 80 extruded in the extrusion direction from some of the slit grooves 941 flows into the gap 910 between the die body part 92 and the guide ring 95. The raw material 80 fed in the gap 910 flows toward the central part of the die body part 92. The front end 951 of the guide ring 95 suppresses the raw material 80 in order to direct the flow toward the central direction of the die body part 92. The raw material 80 in the gap 910 is then guided at the front end 951 of the guide ring 95, and finally forms the outer peripheral skin 83 of the honeycomb structure.

However, a rising part of the corner 943 of the side peripheral surface of the step-shaped part 942 has an angle α′ to the surface of the die body part 92 (namely, into the lateral direction). For example, the rising part of the corner 943 of the step-shaped part 942 takes the angle α=110°. That is, the rising part of the corner 943 of the step-shaped part 942 is tilted toward the central direction of the die body part 92. At the front end 951 of the guide ring 95, the feeding flow of the raw material 80 is turned into the extrusion direction under the condition of having the moving energy into the central direction of the die body part 92.

The conventional extrusion die having the above structure involves a problem of making the outer peripheral skin 83 which is tilted toward the central direction of the die body part 92. As a result, the conventional extrusion die 91 produces the honeycomb structure 8 comprising the cell walls 81 and the outer peripheral skin 83 in which the cell walls 81 adjacent to the outer peripheral skin 83 are tilted and deformed.

### SUMMARY OF THE INVENTION

It is an object of the present invention to provide an extrusion die having an improved structure capable of producing a honeycomb structure with high accuracy and of suppressing any deterioration of the outer peripheral skin shape of the honeycomb structure, and further from inclining the cell walls adjacent to the outer peripheral skin.

To achieve the above purposes, the present invention provides an extrusion die to be used for producing a honeycomb structure. The honeycomb structure comprises a plurality of cell walls arranged in a honeycomb shape, a plurality of cells surrounded by the cell walls, and an outer peripheral skin covering an outer peripheral surface of the honeycomb structure. Through the extrusion die, the cell walls and the outer peripheral skin are formed as one body. The extrusion die is comprised of a guide ring and a die body part.

The guide ring has a pole part and a guide part. The pole part is formed on a die body part in an extrusion direction of the raw material in the extrusion die. The guide part is formed from the pole part in an inside direction of the die body part so that a gap is formed between the guide part and the die body part.

The die body part has a slit groove formation area. The slit groove formation area has a central slit groove formation surface area and an outer peripheral slit groove formation surface area. The central slit groove formation surface area is a step-shaped area having a central slit groove formation surface. The central slit groove formation surface area, namely, the step-shaped area does not face the guide part of the guide ring/In the step-shaped area a plurality of feeding holes and corresponding slit grooves are formed. The outer peripheral slit groove formation surface area is formed in the outside of the central slit groove formation surface area. In the outer peripheral slit groove formation surface area a plurality of slit grooves and corresponding feeding holes are formed.

In the extrusion die, the step-shaped area is so formed that an angle of the outer peripheral side surface of the step-shaped area to the outer peripheral slit groove formation surface is within a range of 90°≦α≦95°. Further, the extrusion die according to the present invention satisfies a relationship A≦B<1.5 A, where A is a gap between the outer peripheral slit groove formation surface to the guide part, and B is a gap between the outer peripheral side surface of the step-shaped part and the front end of the guide part.

The extrusion die according to the present invention is used for producing a honeycomb structure having a plurality of cell walls arranged in a honeycomb shape, cells surrounded by the cell walls, and the outer peripheral skin of a cylindrical shape. The outer peripheral skin covers the cells near the outer peripheral surface of the honeycomb structure.

The extrusion die according to the present invention comprises the die body part and the guide ring. The die body part has the step-shaped part which projects in the extrusion direction of the raw material. The slit groove formation area is composed of the central slit groove formation surface area and the outer peripheral slit groove formation surface area. The die body part has the step-shaped part which does not face the guide part.

The die body part has the slit groove formation surface composed of the central slit groove formation surface (as the step-shaped part) and the outer peripheral slit groove formation surface surrounded by the step-shaped part. The central slit groove formation surface is the slit grooves formation surface of the step shaped part.

On extruding raw material through the extrusion die having the structure according to the present invention, the outer peripheral skin is made using the raw material which has passed through the gap between the die body part and the guide part. That is, the raw material is extruded through the slit grooves formed in the outer peripheral slit groove formation surface, which faces the guide part, and is then fed into the gap, and fed toward the central part of the die body part. The raw material is then guided by the guide part at the front end of the guide part, and thereby turned to the extrusion direction. The outer peripheral skin is formed using the raw material, the flow of which is turned by at the front end of the guide part of the die body part the extrusion direction.

The die body part of the extrusion die according to the present invention has the step-shaped part of a circular shape which projects in the extrusion direction prescribed above. The step-shaped part is so formed that the angle α of the outer peripheral side surface to the outer peripheral slit groove formation surface takes the value within the range of 90°≦α≦95°. Therefore when the feeding direction of the raw material is changed into the extrusion direction at the front end of the guide part and its vicinity, the structure of the outer peripheral side surface of the circular step-shaped part limits the flow of the raw material toward the central part of the die body part of the extrusion die and certainly leads the change of the flowing direction of the raw material in the extrusion direction. This structure of the extrusion die according to the third embodiment results in the production of an outer peripheral skin with uniform thickness in the extrusion direction, and further prevents the outer peripheral skin and/or the cell walls adjacent to the outer peripheral skin from being tilted.

Still further, according to the present invention, the structure of the extrusion die satisfies the relationship A≦B<1.5 A, where A is the gap between the outer peripheral slit groove formation surface and the guide part, and B is the gap between the outer peripheral side surface of the circular step-shaped part and the front end of the guide part. The outer peripheral skin is made using the raw material which is fed through the gap of the distance A and then fed through the gap B between the outer peripheral side surface of the circular step-shaped part and the front end of the guide part. The thickness of the outer peripheral skin is determined by the magnitude of the distance B.

So long as the values A and B satisfy the above relationship, the whole amount of the raw material necessary to make the outer peripheral skin can be supplied through the gap. The structure of the extrusion die of the third embodiment can supply the amount of the raw material adequate to stably produce the honeycomb structure having the outer peripheral skin of uniform thickness.

The structure of the extrusion die according to the present invention can prevent the outer peripheral skin from the deterioration in its shape when producing the honeycomb structure, and further prevents the cell walls adjacent to the outer peripheral skin from being tilted. The structure of the extrusion die according to the present invention can produce the honeycomb structures with high accuracy.

### BRIEF DESCRIPTION OF THE DRAWINGS

A preferred, non-limiting embodiment of the present invention will be described by way of example with reference to the accompanying drawings, in which:

FIG. 1 is an explanatory view showing an extrusion die for molding a honeycomb structure according to a first embodiment of the present invention;

FIG. 2 is a cross section of the extrusion die along A-A line in FIG. 1;

FIG. 3A and FIG. 3B each is an explanatory view showing a die body part of the extrusion die according to the first embodiment shown in FIG. 1;

FIG. 4A to FIG. 4D each is an explanatory view showing a structural relationship between feeding holes and slit grooves formed in the die body part in the extrusion die according to the first embodiment shown in FIG. 1;

FIG. 5 is an explanatory view showing a process of extruding raw material in order to mold a honeycomb structure by using the extrusion die according to the first embodiment shown in FIG. 1;

FIG. 6 is a perspective view of the honeycomb structure as a final product which has been produced by using the extrusion die according to the first embodiment shown in FIG. 1;

FIG. 7 is an explanatory view showing an extrusion die for molding a honeycomb structure according to a second embodiment of the present invention;

FIG. 8 is an explanatory view showing an extrusion die for molding a honeycomb structure according to a third embodiment of the present invention;

FIG. 9 is an explanatory view showing a process of extruding raw material in order to mold a honeycomb structure by using the extrusion die according to the third embodiment shown in FIG. 8; and

FIG. 10 is an explanatory view showing a structure of a conventional extrusion die and an extrusion process of making an outer peripheral skin and cell walls of a honeycomb structure using the conventional extrusion die.

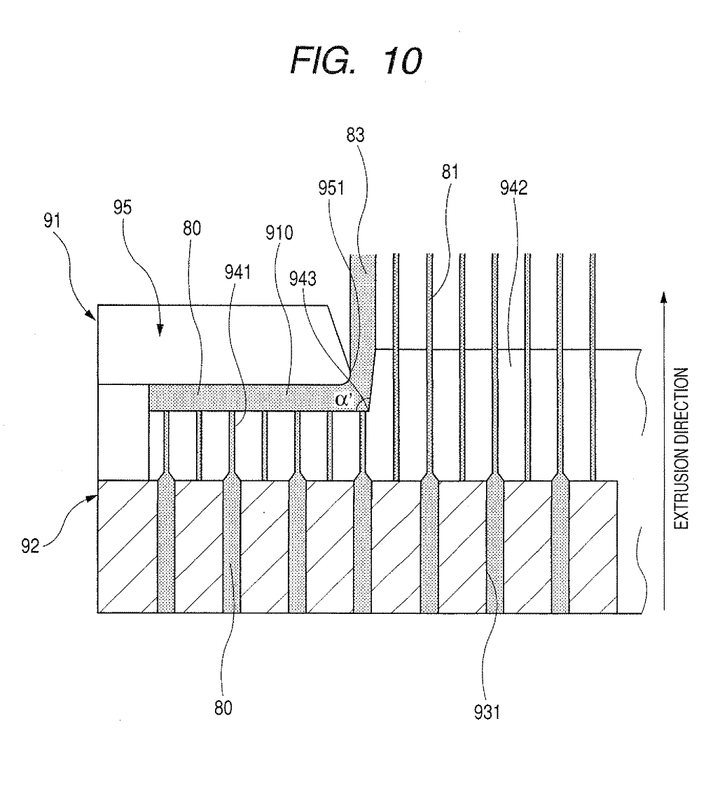

### DETAILED DESCRIPTION OF THE PREFERRED EMBODIMENTS

Hereinafter, various embodiments of the present invention will be 10 described with reference to the accompanying drawings. In the following description of the various embodiments, like reference characters or numerals designate like or equivalent component parts throughout the diagrams.

### First Embodiment

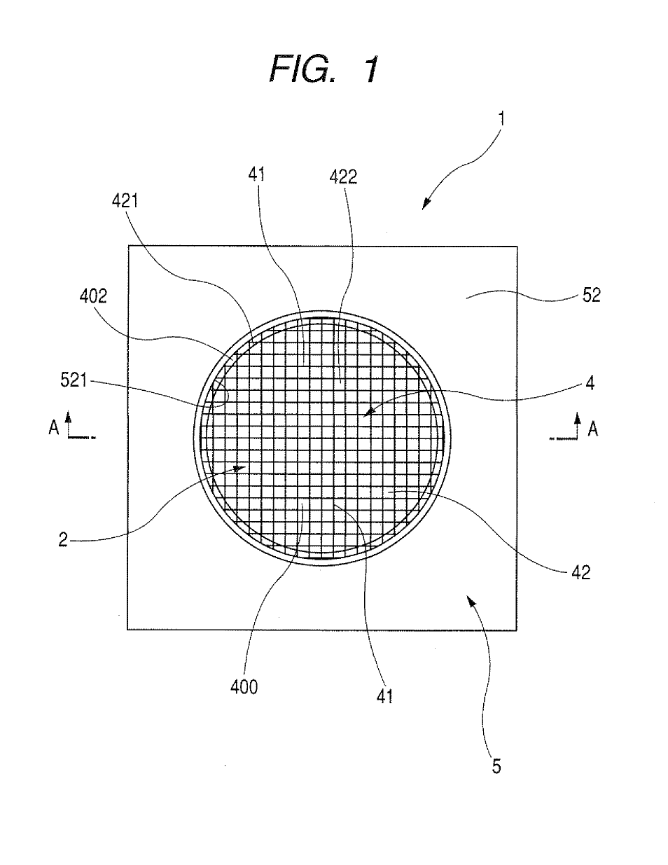

A description will be given of an extrusion die according to the first embodiment with reference to FIG. 1 to FIG. 6.

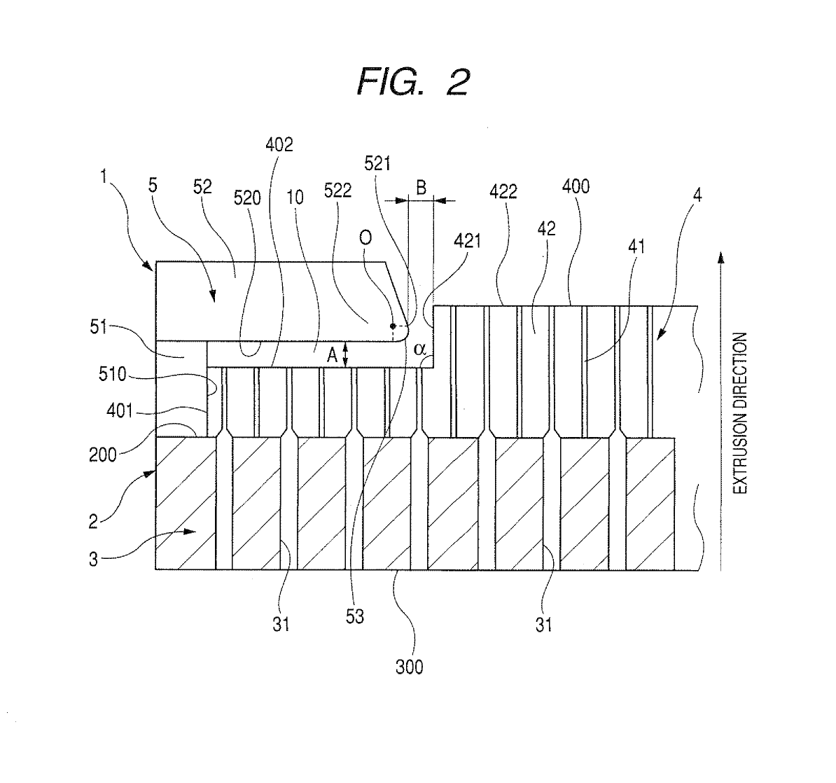

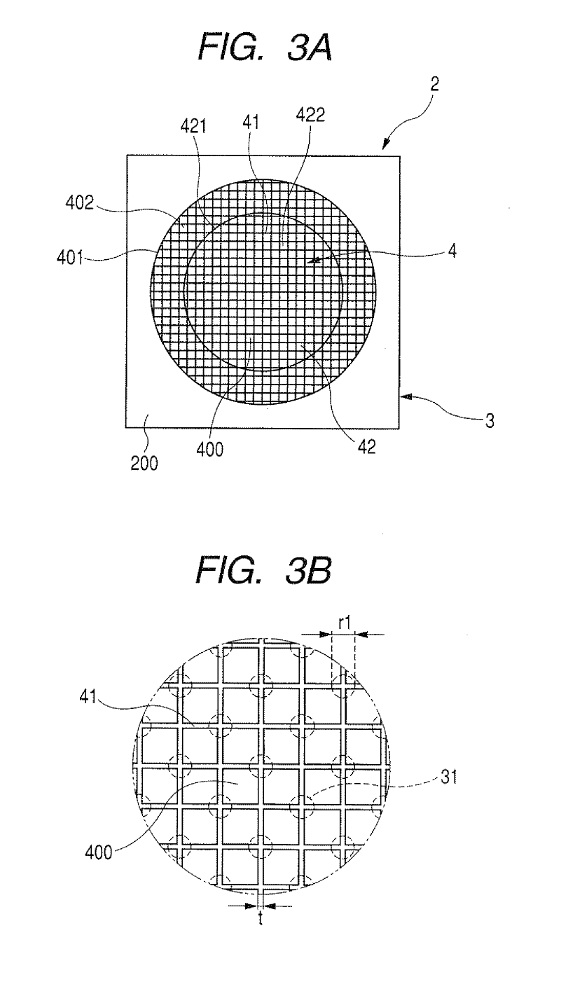

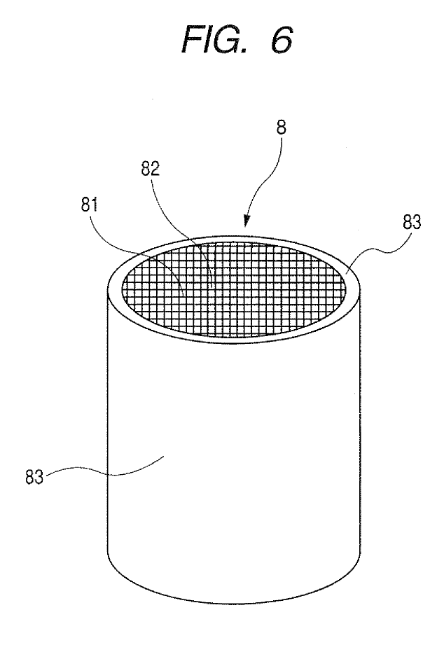

FIG. 1 is an explanatory view showing the extrusion die 1 to be used for molding a honeycomb structure 8 (see FIG. 6) according to the first embodiment. FIG. 2 is a cross section of the extrusion die 1 along A-A line in FIG. 1. FIG. 3A and FIG. 3B, each is an explanatory view showing a die body part 2 of the extrusion die 1 according to the first embodiment shown in FIG. 1.

As shown in FIG. 1, FIG. 2, FIG. 3A and FIG. 3B, the extrusion die 1 is used for molding the honeycomb structure 8. FIG. 6 is a perspective view of the honeycomb structure 6.

As shown in FIG. 6, the honeycomb structure 8 comprises a plurality of cell walls 81, a plurality of cells 82, and an outer peripheral skin 83. The outer peripheral skin 83 has a cylindrical shape and covers the outer peripheral surface of the cell 82 of the honeycomb structure 8. Each cell 82 is surrounded by the cell walls 81. The cell walls 81 are arranged in a honeycomb shape in order to form the cells 82.

As shown in FIG. 1 and FIG. 2, the extrusion die 1 according to the first embodiment is composed mainly of the die body part 2 and a guide ring 5.

The die body part 2 has pin holes (not shown) through which the guide ring 5 is fixed. The guide ring 5 also has pin holes (not shown) through which the die body part 2 is fixed together.

The die body part 2 has a feeding hole part 3 and a slit groove part 4. Feeding holes 31 are formed in the feeding hole part 3. Ceramic raw material is fed through the feeding holes 31 into the slit grooves 41 in the extrusion direction. The slit grooves 41 are arranged in a square lattice shape, namely, a honeycomb shape. Through the slit grooves 41, the ceramic raw material fed from the feeding holes 31 is extruded in order to mold the honeycomb structure 8.

As shown in FIG. 2 and FIG. 3A, the slit groove part 4 having the slit grooves 41 is a circular shaped part which projects from the surrounding part in the die body part 2. The surrounding part surrounds the slit groove part 4 of a circular shape in the die body part 2. The slit grooves 41 are formed in a slit groove formation surface 400 of the slit groove part 4. Each slit groove 41 has a square shape. The slit grooves 41 are arranged in a square lattice shape.

As will be explained later, a circular step-shaped part 42 is formed in the slit groove formation surface 400. The circular step-shaped part 42 is formed in the area which does not face a guide part 52. The guide part 52 will be explained in detail later. The circular step-shaped part 42 projects in the extrusion direction to which the ceramic raw material is fed. The slit groove formation surface 400 is composed of a central slit groove formation surface 422 and an outer peripheral slit groove formation surface 402. The central slit groove formation surface 422 is formed in the circular step-shaped part 42. The outer peripheral slit groove formation surface 402 is formed in the area other then the circular step-shaped part 42 in the slit groove part 4.

As shown in FIG. 2, the feeding hole part 3 has the feeding holes 31 formed in the feeding hole formation surface 300 (which is the opposite surface of the slit groove formation surface 400). The feeding holes 31 are communicated with the slit grooves 41.

As shown in FIG. 3B, each of the feeding holes 31 is formed at the position which corresponds to an alternate lattice point in vertical and lateral directions in the lattice points of the slit grooves 41. Specifically, the inner diameter “r1” of each feeding hole 31 is 1.5 mm, and a groove width “t” of each slit groove 41 is 100 μm.

As shown in FIG. 1 and FIG. 2, the guide ring 5 has a pole part 51 and a guide part 52. The pole part 51 is extended from a reference surface 200 of the die body part 2 in the extrusion direction of ceramic raw material. The guide part 52 is projected from the pole part 51 toward the inside of the die body part 2 so that a gap 10 is formed between the guide part 52 and the slit groove part 4.

The pole part 51 has a ring shape. In order to form the gap 10, it is so formed that the pole part 51 is higher in the extrusion direction than the outer peripheral slit groove formation surface 402 in the slit groove part 4 as shown in FIG. 2. Further, the inner peripheral surface 510 of the pole part 51 is contacted to the outer peripheral surface 401 of the slit groove part 4 of the die body part 2.

The guide part 52 is composed of a guide surface 520 which faces an outer peripheral slit groove formation surface 402 of the slit groove part 4. The guide surface 520 projects toward the inside of the die body part 2 so that the guide surface 520 maintains a gap 10 formed between the guide surface 520 and the outer peripheral slit groove formation surface 402.

The front end 521 of the guide part 52 is a circular shape corresponding to a dimension of the outline of the honeycomb structure 8 to be produced.

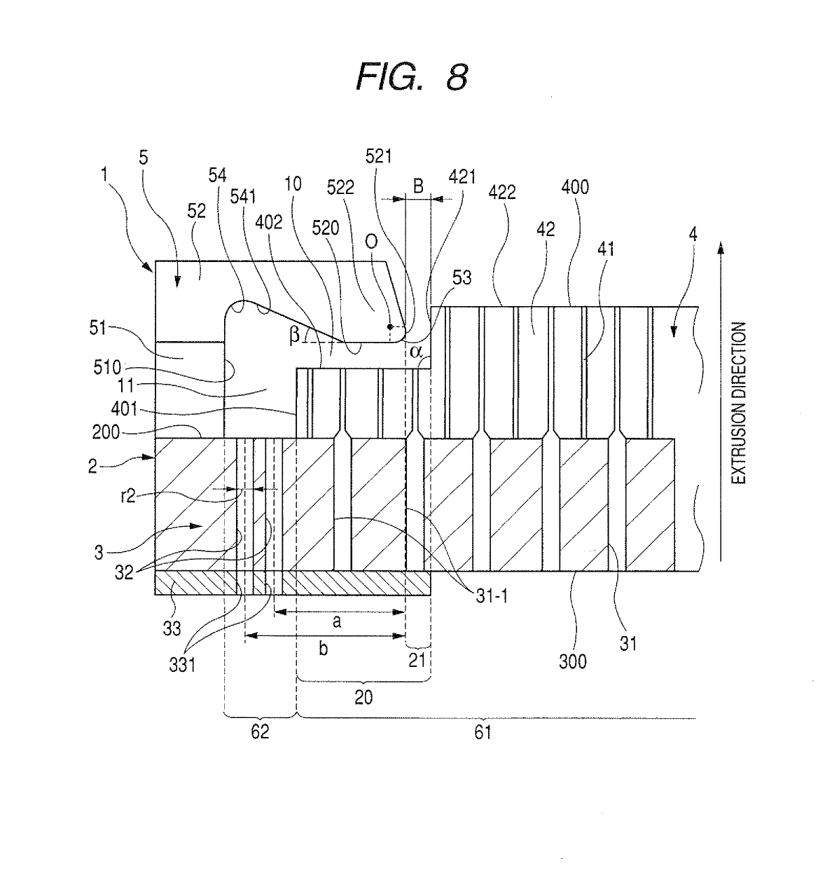

In the structure of the extrusion die 1 according to the first embodiment shown in FIG. 2, the step-shaped part 42 is so formed in the extrusion die 1 according to the first embodiment that the outer peripheral side surface 421 in the step-shaped part 42 is tilted to the outer peripheral slit groove formation surface 402 at angle α within a range of 90°≦α≦95°. FIG. 8 shows one example of α=90°.

The extrusion die 1 according to the first embodiment further satisfies the relationship A≦B<1.5 A, where A is the gap between the outer peripheral slit groove formation surface 402 to the guide part 52 (namely, the distance measured from the outer peripheral slit groove formation surface 402 to the guide part 52), and B is the gap between the outer peripheral side surface 421 of the step-shaped part 42 and the front end 521 of the guide part 52 (namely, the distance in the direction vertical to the extrusion direction 15 measured from the outer peripheral side surface 421 in the circular step-shaped part 42 to the front end 521 of the guide part 52). FIG. 8 shows one example of A=0.4 mm and B=0.55 mm.

In addition, the front end 522 of the guide part 52 is rounded. That is, the front end 522 has a rounded surface 53 (R-surface 53) having a 20 predetermined radius of curvature from the part facing the outer peripheral slit groove formation surface 402 to the part facing the outer peripheral side surface 421. FIG. 2 shows one example of the R-surface 53 having the radius of curvature of 0.3 mm. The central position O of the R-surface 53 formed at the front end 521 shown in FIG. 2 is shifted toward the outer peripheral slit groove formation surface 402 side rather than the outer peripheral surface 401 side.

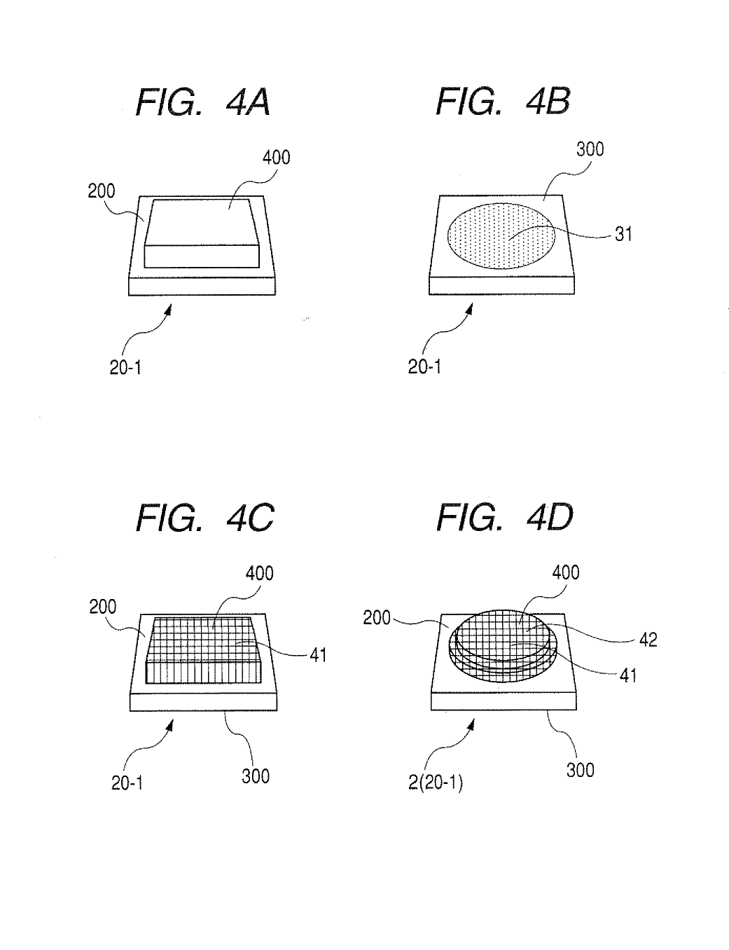

Next, a description will now be given of the method of producing the extrusion die 1 comprising the die body part 2 and the guide ring 5 according to the first embodiment with reference to FIG. 4A to FIG. 4D.

FIG. 4A to FIG. 4D each is an explanatory view showing a structural relationship between the feeding holes 31 and the slit grooves 41 formed in the die body part 2 in the extrusion die 1 according to the first embodiment shown in FIG. 1.

First, a square metal plate made of SKD61 is prepared as a die member 20-1. SKD61 is an alloy tool steel for making die in Japanese Industrial Standards.

As shown in FIG. 4A, the outer peripheral part of the die member 20-1 made of SKD 61 is roughly cut so that the slit groove formation surface 400 projects over its peripheral area (which becomes the reference surface 200).

Next, as shown in FIG. 4B, a plurality of feeding holes 31 is formed using drills in the feeding hole formation surface 300. The feeding hole formation surface 300 is the opposite surface on which the slit groove formation surface 400 is formed.

Next, as shown in FIG. 4C, each slit groove 41 is formed in the slit groove formation surface 400 of the die member 20-1 using a circular grindstone blade (not shown) in order to form the slit grooves 41 arranged in a square lattice shape.

Next, as shown in FIG. 4D, the outer periphery of the slit groove formation surface 400 of the die member 20-1 is finished in a predetermined circular shape. The circular step-shaped part 42 is formed in the central part of the slit groove formation surface 400 so that the circular step-shaped part 42 projects in the central part of the slit groove formation surface 400. The die body part 2 of the extrusion die 1 is thereby made.

Next, the guide ring 5 and the above die body part 2 are assembled into the extrusion die 1. On fixing the guide ring 5 to the die body part 2, the guide ring 5 is placed on the reference surface 200 of the die body part 2, pins (not shown) are inserted into the pin holes (not shown) formed in the die body part 2 and the guide ring 5. At this time, the inner peripheral surface 510 of the pole part 51 of the guide ring 5 is contacted to the outer peripheral surface 401 of the slit groove part 4 of the die body part 2.

The method of making the extrusion die 1 to be used for producing the honeycomb structure 8 is thereby completed.

Next, a description will now be given of the method of producing the honeycomb structure 8 using the extrusion die 1 having the above structure. The extrusion die 1 made by the prescribed method is set at the front end of a screw type extrusion apparatus (not shown). Raw material 80 containing ceramic raw material is mixed and then supplied into the screw type extrusion apparatus. The raw material 80 is composed mainly of cordierite raw material. The cordierite raw material is composed of kaolin, melting silica, aluminium hydroxide, alumina, and talc in a predetermined chemical composition. Water, binder, pore forming agent, and others are added into the cordierite raw material, and those are then mixed in order to make the raw material 80.

Next, the screw type extrusion apparatus (not shown) extrudes the raw material 80 into the extrusion die 1. In the first embodiment, the raw material 80 is supplied into the feeding holes 31 of the extrusion die 1.

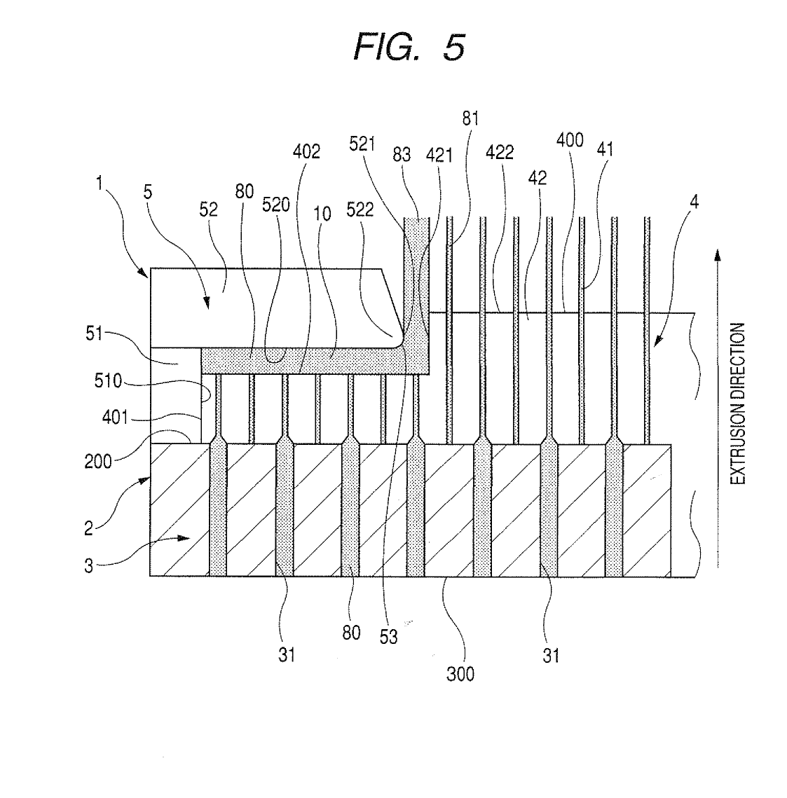

FIG. 5 is an explanatory view showing the process of molding the honeycomb structure 8 using the extrusion die 1 according to the first embodiment shown in FIG. 1.

As shown in FIG. 5, the raw material 80 is fed from the feeding holes 31. The raw material SO fed from the outer peripheral slit groove formation surface 402 then passes the gap 10, and finally forms the outer peripheral skin 83. As shown in FIG. 5, the raw material 80 extruded through the central slit groove formation surface 422 directly forms the cell walls 81 arranged in a square lattice shape.

FIG. 6 is a perspective view of the honeycomb structure 8 as a final product which has been produced using the extrusion die 1 according to the first embodiment shown in FIG. 1.

The outer peripheral skin 83 and the cell walls 81 are simultaneously formed by using the extrusion die 1 As shown in FIG. 6, the honeycomb structure 8 is composed mainly of the cell walls 81, the cells 82 surrounded by the cell walls 81, and the outer peripheral skin 83.

An extruded green body made of ceramic is extruded through the extrusion die 1. The extruded green body made of ceramic is then dried and fired at a predetermined temperature for a predetermined length of time in order to produce the honeycomb structure 8 made of cordierite ceramic as a final product.

Next, a description will now be given of actions and effects of the extrusion die 1 according to the first embodiment of the present invention.

The die body part 2 of the extrusion die 1 according to the first embodiment has the step-shaped part 42 which projects in the extrusion direction of the raw material. The step-shaped part 42 is formed in the slit groove formation surface 400 which does not face the guide part 52. Further, this die body part 2 has the outer peripheral slit groove formation surface 402 and the central slit groove formation surface 422, where the outer peripheral slit groove formation surface 402 is the slit groove formation surface 400 of the step-shaped part 42 and the central slit groove formation surface 422 is the slit groove formation surface 400 in the peripheral area of the step-shaped part 42.

On extruding the raw material 80 through the extrusion die 1, the outer peripheral skin 83 is made using the raw material 80 which is fed through the gap 10 between the die body part 2 and the guide part 52. That is, the raw material 80 extruded through the slit grooves 41 in the outer peripheral slit groove formation surface 402 is fed into the gap 10 and then transmitted toward the central direction of the die body part 2. At the front end 521 of the guide part 52, the raw material 80 is guided by the guide part 52, and the feeding flow thereof is then turned in the extrusion direction in order to make the outer peripheral skin 83.

The die body part 2 of the extrusion die 1 has the circular step-shaped part 42 which projects in the extrusion direction prescribed above. The circular step-shaped part 42 is so formed that the angle α of the outer peripheral side surface 421 to the outer peripheral slit groove formation surface 402 takes the value within the range of 90°≦α≦95°. Therefore when the feeding direction of the raw material 80 is changed in the extrusion direction at the front end 521 of the guide part 52 and its vicinity, the structure of the outer peripheral side surface 421 of the circular step-shaped part 42 limits the flow of the raw material 80 toward the central part of the die body part 2 of the extrusion die I and certainly leads the change of the flowing direction of the raw material 80 in the extrusion direction. This structure of the extrusion die 1 according to the first embodiment ensures that the outer peripheral skin 83 is formed in the extrusion direction and has a uniform thickness. Further, the structure of the extrusion die 1 prevents that the outer peripheral skin 83 and/or the cell walls 81 adjacent to the outer peripheral skin 83 is tilted.

Still further, according to the present invention, the structure of the extrusion die 1 according to the first embodiment satisfies the relationship A≦B<1.5 A, where A is the gap between the outer peripheral slit groove formation surface 402 to the guide part 52 (namely, the distance measured from the outer peripheral slit groove formation surface 402 to the guide part 52), and B is the gap between the outer peripheral side surface 421 of the circular step-shaped part 42 and the front end 521 of the guide part 52 (namely, the distance in the direction vertical to the extrusion direction measured from the outer peripheral side surface 421 of the circular step-shaped part 42 to the front end 521 of the guide part 52). The outer peripheral skin 83 is made using the raw material 80 which is fed through the gap 10 of the distance A and then fed through the gap between the outer peripheral side surface 421 of the circular step-shaped part 42 and the front end 521 of the guide part 52. The thickness of the outer peripheral skin 83 is determined by the magnitude of the distance B.

So long as the values A and B satisfy the above relationship, the total amount of the raw material 80 necessary to make the outer peripheral skin 83 can be supplied through the gap 10. The structure of the extrusion die of the first embodiment can supply the amount of the raw material adequate to stably produce the honeycomb structure having the outer peripheral skin 83 of uniform thickness.

According to the first embodiment of the present invention, the extrusion die having the above structure can make the honeycomb structure 8 with high accuracy because of the ability to suppress the outer peripheral skin 83 from any deterioration in shape, and to suppress the cell walls 81 adjacent the outer peripheral skin 83 from deformation when molding the honeycomb structure 8.

### Second Embodiment

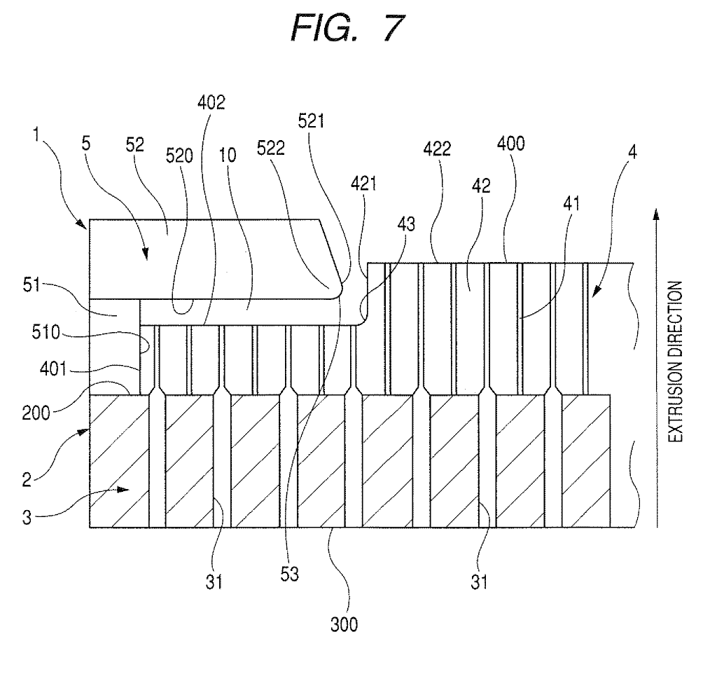

A description will now be given of the extrusion die according to the second embodiment of the present invention with reference to FIG. 7.

FIG. 7 is an explanatory view showing the extrusion die for molding a honeycomb structure according to the second embodiment.

As shown in FIG. 7, a rounded surface 43 (or R-surface 43) having a predetermined curvature is formed at the corner part between the outer peripheral slit groove formation surface 402 and the outer peripheral side surface 421 of the step-shaped part 42. FIG. 7 shows one example in which the R-surface 43 at the corner part has the radius of curvature of 0.3 mm.

In the structure of the extrusion die shown in FIG. 7, the feeding direction of the raw material 80 at the outer peripheral side surface 421 of the step-shaped part 42 is changed more smoothly in the extrusion direction by the R-surface 43 at the corner part.

Other components of the extrusion die 1 according to the second embodiment are the same as those of the extrusion die 1 of the first embodiment. The extrusion die according to the second embodiment of the present invention has the same actions and effects of the extrusion die of the first embodiment.

### Third Embodiment

A description will now be given of the extrusion die according to the third embodiment of the present invention with reference to FIG. 8.

The extrusion die according to the third embodiment shown in FIG. 8 has a modification of the extrusion die according to the first embodiment shown in FIG. 2 and FIG. 5.

FIG. 8 is an explanatory view showing the extrusion die for molding a honeycomb structure according to the third embodiment.

As shown in FIG. 8, the die body part 2 has a feeding hole formation area 62 (as a secondary formation area) having the feeding holes 32 (as the secondary feeding holes) through which the ceramic raw material is fed in order to make the outer peripheral skin 83. The feeding hole formation area 62 is formed in the outside area of the slit groove formation area 61 (as a primary formation area) so that the feeding hole formation area 62 surrounds the slit groove formation area 61 in the die body part 2. This slit groove formation area 61 includes the slit groove formation surface 400 and the outer peripheral slit groove formation surface 402.

The plurality of feeding holes 32 are formed in the feeding hole formation area 62. The feeding holes 32 penetrate in the die body part 2. Through the feeding holes 32, a raw material feeding path 11 (which will be explained later), and the gap 10, the raw material is fed, namely, supplied in order to form the outer peripheral skin 83 in the extrusion direction.

The feeding holes 32 are formed in two ring-shaped rows (as a primary row and a secondary row) in the feeding hole formation area 62. The inner diameter “r2” of the feeding hole 32 is 1.5 mm.

Each feeding hole 32 in each row in the feeding hole formation area 62 has the same lateral-length which is measured in a vertical direction to the extrusion direction of the ceramic raw material from the front end 521 of the guide part 52 to the position corresponding to each feeding hole 32.

That is, in the structure of the die body part 2 according to the third embodiment, as shown in FIG. 8, the shortest length “a” is 7.0 mm, which is measured from the center of each feeding hole 32 in the primary row to the front end 521 of the guide part 52. On the other hand, the shortest length “b” is 10.0 mm, which is measured from the center of each feeding hole 32 in the secondary row (the outside raw) to the front end 521 of the guide part 52.

Further, as shown in FIG. 8, the raw material feeding path 11 is formed between the inner peripheral surface 510 of the pole part 51 and the outer peripheral surface 401 of the slit groove part 4 in the die body part 2. The raw material feeding path 11 feeds the ceramic raw material which is fed through feeding holes 32 (as secondary feeding holes) in order to make the outer peripheral skin 83.

As shown in FIG. 8, the die body part 2 has a feeding hole sealing area 20 in which the feeding holes 31-1 are sealed, through which no ceramic raw material is fed. The feeding hole sealing area 20 includes an area 21. The outer peripheral slit groove formation surface 402 in the area 21 in the feeding hole sealing area 20 does not face the guide part 52.

In the structure of the extrusion die 1 according to the third embodiment, a sealing member 33 of a ring shape is fitted to the feeding hole formation surface 300. The sealing member 33 of a ring shape prevents the feeding holes 31-1 in the feeding hole sealing area 20 from the supply of the raw material 80. The sealing member 33 of a ring shape is so formed to seal all the feeding holes 31-1 formed in the outside area of the circular step-shaped part 42. In particular, the sealing member 33 of a ring shape has penetration holes 331 which communicate with the feeding holes 32 in order to supply and feed the raw material in order to make the outer peripheral skin 83.

Still further, as shown in FIG. 8, a ring shaped pool-groove 54 is formed along the whole circumference of the inside of the guide part 52 in the guide ring 5. The ring shaped pool-groove 54 is a concave-curved part formed in the extrusion direction from the guide surface 520 toward the inner peripheral surface 510 of the pole part 51. The guide surface 520 faces the outer peripheral slit groove formation surface 402 in the slit groove part 4.

The inner surface of the ring shaped pool-groove 54 has a pool-groove slope 541. The depth of the pool-groove slope 541 is gradually decreased from the inner peripheral surface 510 toward the front end 521 of the guide part 52.

The slope angle β of the pool-groove slope 541 to the guide surface 520 is within a range of 10°≦β≦20°. FIG. 8 shows one example of β=15°.

Other components of the extrusion die according to the third embodiment are the same as those of the first embodiment.

Next, a description will now be given of the method of producing the honeycomb structure 8 using the extrusion die according to the third embodiment.

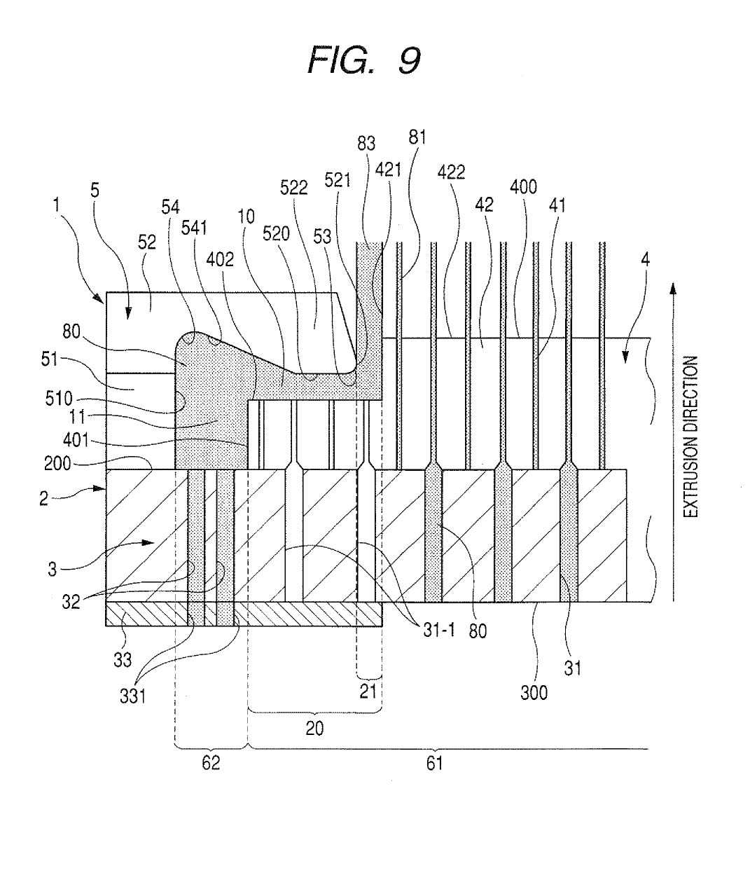

FIG. 9 is an explanatory view showing a process of molding the honeycomb structure 8 using the extrusion die 1 according to the third embodiment shown in FIG. 8.

At first, as shown in FIG. 9, the raw material SO is fed into the feeding holes 31 and 32. The feeding holes 32 feed the raw material 80 for only making the outer peripheral skin 83 of the honeycomb structure 8. In the third embodiment, no raw material 80 is supplied to the feeding holes 31-1 formed in the feeding hole sealing area 20 because those feeding holes 31-1 in the area 20 are sealed by the sealing member 33.

The raw material 80 fed into the feeding holes 32 is transmitted from the reference surface 200 to the ring shaped pool-groove 54 through the raw material feeding path 11 and the gap 10, and temporarily accumulated in this ring shaped pool-groove 54.

The raw material 80 is then transmitted into the gap 10 again from the ring shaped pool-groove 54, and finally fed toward the central part of the die body part 2. The raw material 80 is then guided by the guide part 52 of the guide ring 5 in order to finally make the outer peripheral skin 83.

On the other hand, the cell walls 81 are formed in a square lattice shape by using the raw material 80 which is extruded through slit grooves 41 and the central slit groove formation surface 422.

Other steps of forming the honeycomb structure 8 are the same as those in the first embodiment.

A description will now be given of the actions and effects of the extrusion die according to the third embodiment of the present invention.

In the structure of the extrusion die 1 according to the third embodiment of the present invention, the feeding hole formation area 62 is formed at the outside area of the slit groove formation area 61 in the die body part 2 so that the feeding hole formation area 62 surrounds the slit groove formation area 61. In the feeding hole formation area 62, the feeding holes 32 are formed in rows of a ring-shape arrangement. Through the feeding holes 32, the raw material 80 is supplied in order to make the outer peripheral skin 83 of the ceramic structure 8.

In particular, the extrusion die 1 according to the first embodiment of the present invention has the structure in which the raw material 80 to be used for only making the outer peripheral skin 83 is mainly supplied from the feeding holes 32 formed in the feeding hole formation area 62 which is the outside area of the slit groove formation area 61.

In the structure of the extrusion die 1 of the third embodiment, each feeding hole 32 in each ring-shaped row has a same distance (designated by the reference characters “a” and “b” as shown in FIG. 8) which is measured in the direction from the front end 521 of the guide part 52 to the center of diameter of each feeding hole 32.

According to the above structure, in order to make the outer peripheral skin 83, the raw material 80 reaches the front end 521 of the guide part 52 of the guide ring 5 from each feeding hole 32 in each ring-shaped row by an equidistant-distance movement. In other words, this structure of the extrusion die 1 of the third embodiment enables that each feeding hole 32 in each row supplies a same amount of ceramic raw material to the front end 521 of the guide part 52. It is thereby possible to suppress variation of supplying the ceramic raw material for making the outer peripheral skin 83, and therefore possible to form the outer peripheral skin 83 of a uniform thickness.

The die body part 2 has the area 21. The outer peripheral slit groove formation surface 402 in the area 21 does not face the guide part 52. The sealing member 33 is formed on the opposite surface of the die body part shown in FIG. 8 so that the feeding holes 31-1 in the feeding hole sealing area 20 including the area 21 do not feed the raw material by the sealing member 33. On producing the honeycomb structure 8, no raw material 80 to be used for making the outer peripheral skin 83 is fed through the feeding holes 31-1 and extruded through the corresponding slit grooves 41 formed in the feeding hole sealing area 20 including the area 21.

That is, on producing the honeycomb structure 8, the outer 20 peripheral skin 83 is made only by using the raw material 80 which is fed through the gap 10 between the die body part 2 and the guide part 52. Specifically, the raw material 80 which is fed into the gap 10 through the feeding holes 32 formed in the outside area of the area 20 is further fed toward the central direction of the die body part 2 through the inside of the gap 10.

At the front end 521 of the guide part 52, the raw material 80 is guided by the guide part 52 in the extrusion direction on preventing the raw material 80 to be supplied toward the central part of the die body part 2 by the circular step-shaped part 42. The outer peripheral skin 83 is made under such a feeding control of the raw material 80 by the guide part 52 and the circular step-shaped part 42. The structure of the extrusion die 1 according to the third embodiment enables that the outer peripheral skin 83 is made only using the raw material 80 which is fed into the same direction. As a result, it is possible to stably make the outer peripheral skin 83 with high accuracy by using the extrusion die according to the present invention. The use of the extrusion die according to the present invention can avoid the production of the honeycomb structures having the outer peripheral skin of non-uniform thickness and a low stress resistance.

In the structure of the extrusion die according to the third embodiment, the ring shaped pool-groove 54 is formed along the whole circumference of the guide part 54 of the guide ring 5. The ring shaped pool-groove 54 is a concave-curved part formed in the extrusion direction from the guide surface 520 toward the inner peripheral surface 510 of the pole part 51. The guide surface 520 faces the outer peripheral slit groove formation surface 402 in the slit groove part 4. The raw material 80 fed through the feeding holes 32 passes through the raw material feeding path 11, and flows into the ring shaped pool-groove 54 and is accumulated therein. The raw material 80 accumulated in the ring shaped pool-groove 54 then flows toward the central direction of the die body part 2. The raw material 80 is then guided in the extrusion direction by the guide part 52 of the guide ring 5. The outer peripheral skin 83 of the honeycomb structure 8 is thereby made.

That is, on using the extrusion die according to the third embodiment, the raw material 80 is temporarily accumulated or stored in the ring shaped pool-groove 54, and then fed into the central direction of the die body part 2. The above structure of the extrusion die can realize a stable feeding condition of the raw material 80, in other words, can uniform the feeding amount of, the feeding speed of, and the feeding direction of the raw material 80. It is thereby possible to decrease and suppress the thickness variation of the outer peripheral skin 83 as small as possible, and to provide the honeycomb structures having the outer peripheral skin 83 with superior uniform shape.

Still further, according to the third embodiment, the pool-groove slope 541 is formed in the inner surface of the ring shaped pool-groove 54 so that the depth of the ring shaped pool-groove 54 is gradually decreased toward the front end 521 of the guide part 52. The slope angle β of the pool-groove slope 541 to the guide surface 520 is within a range of 10°≦β≦20°. The pool-groove slope 541 formed in the ring shaped pool-groove 54 having the slope angle β within a range of 10°≦β≦20° can gradually apply the press to the raw material 80. It is thereby possible to supply the raw material 80 with a high density toward the central direction of the die body part 2 and also to make the outer peripheral skin 83 with high accuracy.

Other actions and effects of the extrusion die according to the third embodiment are the same as those of the extrusion die according to the first embodiment.

### Other Effects of the Present Invention

In the extrusion die according to the present invention, the extrusion direction is the direction to which the raw material is extruded through the extrusion die. The slit groove formation surface is the surface in which the slit grooves are formed. Further, it is possible to adopt various shapes such as a triangle shape, a square shape, and a hexagonal shape as the lattice shape of the slit grooves according to the shape of the cell walls in the honeycomb structure.

As prescribed above in detail, the structure of the extrusion die according to the present invention satisfies the relationship A≦B<1.5 A, where A is the gap between the outer peripheral slit groove formation surface and the guide part, and B is the gap between the outer peripheral side surface of the step-shaped part and the front end of the guide part.

By the way, when B<A, there is a possibility of supplying an excess amount of the raw material in order to form the outer peripheral skin of a desired thickness. There is therefore a possibility of a difficulty in stably producing the honeycomb structure with a desired thickness.

On the other hand, when B≧1.5 A, there is a possibility of lacking the necessary amount of the raw material in order to form the outer peripheral skin of a desired thickness. There is therefore a possibility of encountering difficulty in stably producing the honeycomb structures with a desired thickness.

In the extrusion die as another aspect of the present invention, it is preferable that a rounded surface of a predetermined curvature is formed at the front end of the guide part in an area from a part facing the outer peripheral slit groove formation surface to an outer peripheral side surface of the step-shaped part. On this condition, it is possible to smoothly turn the feeding of the raw material into the extrusion direction at the front end of the guide part.

In the extrusion die as another aspect of the present invention, it is preferable that the radius of curvature of the rounded surface at the front end of the guide ring is not more than 0.5 mm. On the condition of exceeding 0.5 mm of the curvature of the R surface at the front end of the guide part, there is a possibility of decreasing the effect obtained by the presence of the R-surface.

In the extrusion die as another aspect of the present invention, it is preferable that a central position of a circle indicated by the rounded surface at the front end of the guide ring is placed in the outer peripheral slit groove formation surface side rather than the central slit groove formation surface side. On this condition, because the step-shaped part has an adequate height, it is possible to control the feeding of the raw material toward the central part of the die body part by the presence of the step-shaped part, and further to completely turn the feeding direction of the raw material into the extrusion direction.

In the extrusion die as another aspect of the present invention, it is preferable that a rounded surface of a predetermined radius of curvature is formed at a corner between the outer peripheral slit groove formation surface and the outer peripheral side surface of the step-shaped part. On this condition, it is possible to smoothly turn the feeding direction of the raw material into the extrusion direction at the area near the outer peripheral side surface of the step-shaped part by the R-surface formed at the corner between the outer peripheral slit groove formation surface and the outer peripheral side surface of the step-shaped part.

In the extrusion die as another aspect of the present invention, it is preferable that the radius of curvature of the rounded surface formed at the corner between the outer peripheral slit groove formation surface and the outer peripheral side surface of the step-shaped part is not more than 0.5 mm. When the radius of curvature of the R-surface exceeds 0.5 mm, there is a possibility of decreasing the effect of the presence of the rounded surface formed at the corner.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. An extrusion die to be used for producing a honeycomb structure comprising a plurality of cell walls arranged in a honeycomb shape, a plurality of cells surrounded by the cell walls, and an outer peripheral skin covering an outer peripheral surface of the honeycomb structure, the extrusion die producing the cell walls and the outer peripheral skin as one body, the extrusion die comprising a guide ring and a die body part,
wherein
the guide ring comprises:
a pole part formed on a die body part in an extrusion direction of the raw material in the extrusion die; and
a guide part formed from the pole part in an inside direction of the die body part so that a gap is formed between the guide part and a die body part, and
the die body part comprising a slit groove formation area comprising:
a central slit groove formation surface area having a step-shaped area, in which a central slit groove formation surface of the step-shaped area does not face the guide part of the guide ring, in which a plurality of feeding holes and corresponding slit grooves are formed; and
an outer peripheral slit groove formation surface area having an outer peripheral slit groove formation surface formed in the outside of the central slit groove formation surface area, and in the outer peripheral slit groove formation surface area a plurality of slit grooves and corresponding feeding holes are formed,
wherein the step-shaped area is so formed that an angle of the outer peripheral side surface of the step-shaped area to the outer peripheral slit groove formation surface is within a range of 90°≦α≦95°, and
the extrusion die satisfies a relationship A≦B<1.5 A, where A is a gap between the outer peripheral slit groove formation surface to the guide part, and B is a gap between the outer peripheral surface of the step-shaped part and the front end of the guide part.

2. The extrusion die according to claim 1, wherein a rounded surface of a predetermined curvature is formed at the front end of the guide part in an area from a part facing the outer peripheral slit groove formation surface to an outer peripheral side surface of the step-shaped part

3. The extrusion die according to claim 1, wherein a radius of curvature of the rounded surface at the front end of the guide ring is not more than 0.5 mm.

4. The extrusion die according to claim 2, wherein a central position of a circle indicated by the rounded surface at the front end of the guide ring is placed in the outer peripheral slit groove formation surface side rather than the central slit groove formation surface side.

5. The extrusion die according to claim 3, wherein a central position of a circle indicated by the rounded surface at the front end of the guide ring is placed in the outer peripheral slit groove formation surface side rather than the central slit groove formation surface side.

6. The extrusion die according to claim 1, wherein a rounded surface of a predetermined curvature is formed at a corner between the outer peripheral slit groove formation surface and the outer peripheral side surface of the step-shaped part.

7. The extrusion die according to claim 2, wherein a rounded surface of a predetermined curvature is formed at a corner between the outer peripheral slit groove formation surface and the outer peripheral side surface of the step-shaped part.

8. The extrusion die according to claim 3, wherein a rounded surface of a predetermined curvature is formed at a corner between the outer peripheral slit groove formation surface and the outer peripheral side surface of the step-shaped part.

9. The extrusion die according to claim 4, wherein a rounded surface of a predetermined curvature is formed at a corner between the outer peripheral slit groove formation surface and the outer peripheral side surface of the step-shaped part.

10. The extrusion die according to claim 6, wherein a radius of curvature of the rounded surface formed at the corner between the outer peripheral slit groove formation surface and the outer peripheral side surface of the step-shaped part is not more than 0.5 mm.
